(19) United States
(12) Patent Application Publication
(10) Pub. No.: US 2025/0217431 A1
(43) Pub. Date: Jul. 3, 2025

(54) PASSING DATA VIA AN INLINE CONTENT ELEMENT

(71) Applicant: Capital One Services, LLC, McLean, VA (US)

(72) Inventor: Bryan TAMAYO, Allen, TX (US)

(21) Appl. No.: 18/398,314

(22) Filed: Dec. 28, 2023

(51) Int. Cl. G06F 16/958

(52) U.S. Cl. CPC G06F 16/986; G06F 16/972

(57) ABSTRACT

In some implementations, a user device may transmit a request for a document. The user device may receive the document in response to the request. The document may include code and an inline content element having a source attribute. The user device may transmit, due to execution of the code, a data request relating to a user. The user device may receive, in response to the data request, user data relating to the user. The user device may insert, due to execution of the code, a resource address appended with the user data into the source attribute of the inline content element. The user device may transmit to a second host device, and as a result of inserting the resource address appended with the user data into the source attribute, an additional request for a resource that passes the user data appended to the resource address to the resource.

### BACKGROUND

Web pages, when displayed by a web browser, may include content from a number of domains. An inline frame (iframe), for example, is one type of markup element that can be placed within a web page to display a hypertext markup language (HTML) document that is received from a domain different than a domain associated with the main web page. Communication between an iframe, associated with one domain, and the main web page (e.g., a container frame), associated with a second domain, may be restricted.

### SUMMARY

Some implementations described herein relate to a system for passing data between devices. The system may include one or more memories and one or more processors communicatively coupled to the one or more memories. The one or more processors may be configured to transmit, to a first host device, a request for a web page to be loaded in a web browser, where the request is responsive to a user input from a user that is authenticated to access the web page. The one or more processors may be configured to receive, from the first host device, the web page in response to the request, where the web page includes code executable by the web browser and an inline content element having a source attribute. The one or more processors may be configured to execute the code in an environment of the web browser. The one or more processors may be configured to transmit, due to execution of the code and to a service endpoint, a data request that includes a user identifier of the user. The one or more processors may be configured to receive, from the service endpoint in response to the data request, user data relating to the user. The one or more processors may be configured to modify, due to execution of the code, the source attribute of the inline content element to indicate a resource address appended with the user data, where the resource address indicates a resource. The one or more processors may be configured to transmit, as a result of modification of the source attribute and to a second host device, an additional request for the resource that passes the user data appended to the resource address to the resource.

Some implementations described herein relate to a method of passing data between devices. The method may include transmitting, by a user device to a first host device, a request for a document, where the user device is used by a user. The method may include receiving, by the user device from the first host device, the document in response to the request, where the document includes code and an inline content element having a source attribute. The method may include transmitting, by the user device and due to execution of the code, a data request relating to the user. The method may include receiving, by the user device and in response to the data request, user data relating to the user. The method may include inserting, by the user device and due to execution of the code, a resource address appended with the user data into the source attribute of the inline content element in a document object model of the document, where the resource address indicates a resource. The method may include transmitting, by the user device, to a second host device, and as a result of inserting the resource address appended with the user data into the source attribute, an additional request for the resource that passes the user data appended to the resource address to the resource.

Some implementations described herein relate to a non-transitory computer-readable medium that stores a set of instructions for passing data between devices. The set of instructions, when executed by one or more processors of a device, may cause the device to transmit a request for a document. The set of instructions, when executed by one or more processors of the device, may cause the device to receive the document in response to the request, where the document includes code and an inline content element having a source attribute. The set of instructions, when executed by one or more processors of the device, may cause the device to execute the code. The set of instructions, when executed by one or more processors of the device, may cause the device to transmit, due to execution of the code, a data request. The set of instructions, when executed by one or more processors of the device, may cause the device to receive, in response to the data request, user data relating to a user. The set of instructions, when executed by one or more processors of the device, may cause the device to modify, due to execution of the code, the source attribute of the inline content element to indicate a resource address appended with the user data, where the resource address indicates a resource, and where modification of the source attribute is to cause passing of the user data appended to the resource address to the resource.

### BRIEF DESCRIPTION OF THE DRAWINGS

FIGS. 1A-1F are diagrams of an example associated with passing data via an inline content element, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with passing data via an inline content element, in accordance with some embodiments of the present disclosure.

FIG. 4 is a flowchart of an example process associated with passing data via an inline content element, in accordance with some embodiments of the present disclosure.

### DETAILED DESCRIPTION

The following detailed description of example implementations refers to the accompanying drawings. The same reference numbers in different drawings may identify the same or similar elements.

To track user activity on a website, code configured to monitor the user activity may be embedded in one or more web pages being tracked. Generally, the code may be configured to collect various information relating to users and user interactions with the web pages, and to transmit the information to a backend system, where the information can be formatted, analyzed, displayed, or the like. Moreover, the information can be used to enhance the website by enabling dynamic content, personalized content, or the like, based on the information.

In some examples, a service provider may provide hosting services, whereby an entity can create and publish content (e.g., an intranet website) that is hosted on the service provider's servers. The service provider may provide a content management system that enables the entity to create and publish content. The content management system may allow the entity to add custom code to content that is created. However, even with the ability to add custom code, the entity may be unable to configure the custom code to transmit captured user data to a server maintained or controlled by the entity. This is because web browsers employ cross-domain restrictions, also known as same-origin policies, which are security policies that restrict interactions between resources under different domains. Without the ability to capture the user data, the content may lack robustness and may have limited functionality, such as a lack of dynamic content or personalized content.

Some implementations described herein enable the passing of data from a document (e.g., a web page) served by a first host device to a resource (e.g., a serverless application) residing at a second host device. For example, the document and the resource may be accessible at different domains. In some implementations, the document may include code (e.g., executable by a web browser) and an inline content element (e.g., an iframe) having a source attribute. Execution of the code may cause transmission of a data request (e.g., to an application programming interface (API) endpoint) for user data relating to a user accessing the document, and the user data may be returned in response to the data request. Moreover, execution of the code may cause modification of the source attribute to indicate a resource address, for the resource, appended with the user data. Thus, modification of the source attribute causes an additional request to be made to the resource address appended with the user data, thereby passing the user data to the resource.

In this way, techniques described herein enable interactions between resources on different host devices and under different domains. Moreover, the second host device, using the resource, can generate dynamic content, based on the user data, that is returned and loaded into the inline content element in response to the additional request. Accordingly, techniques described herein improve the robustness and the functionality of the document by enabling dynamic and/or personalized content. Furthermore, techniques described herein allow the dynamic content to be loaded into the same document from which the user data, used to dictate the dynamic content, is collected. Thus, dynamic content can be provided relatively sooner in the user's session, and a number of server requests that need to be made before relevant content is provided to the user can be reduced, thereby conserving computing resources and network resources.

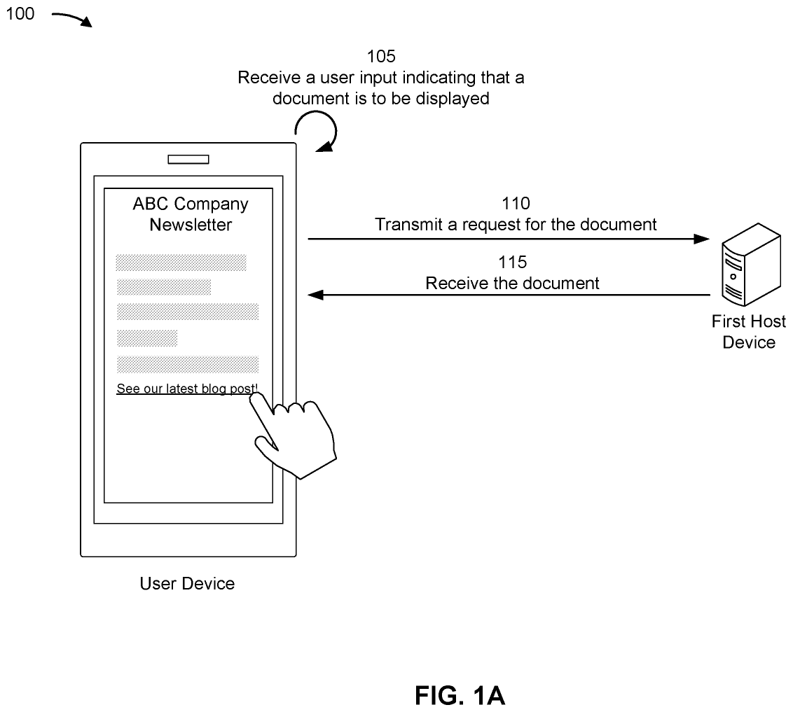

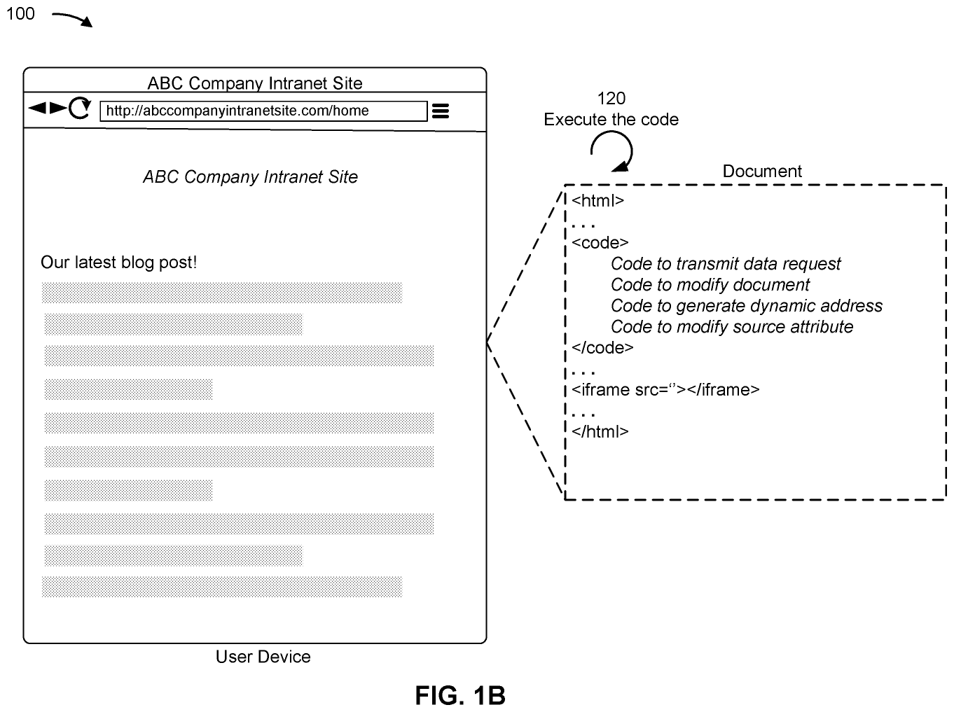

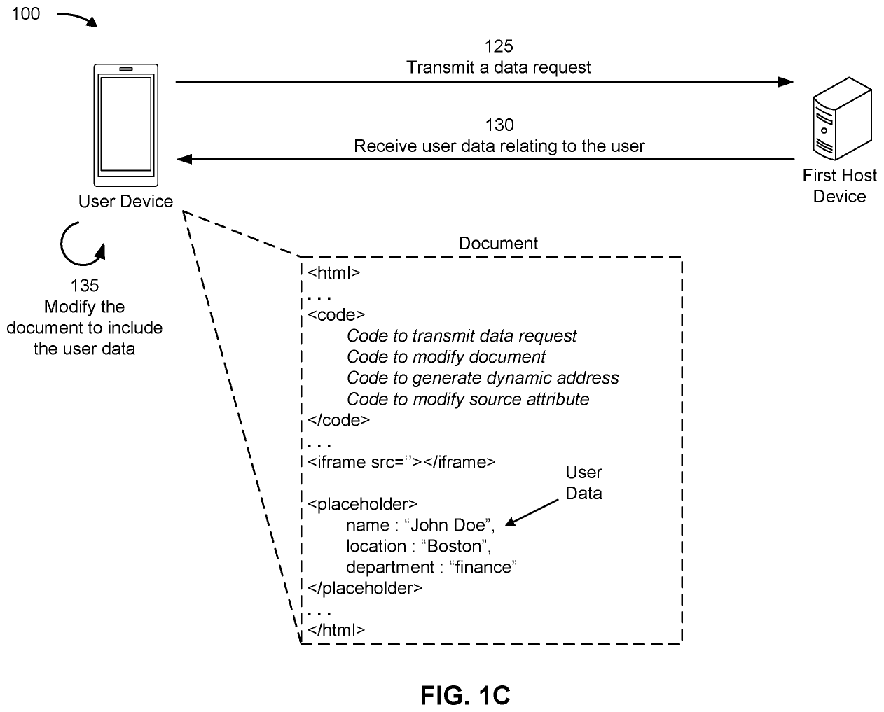

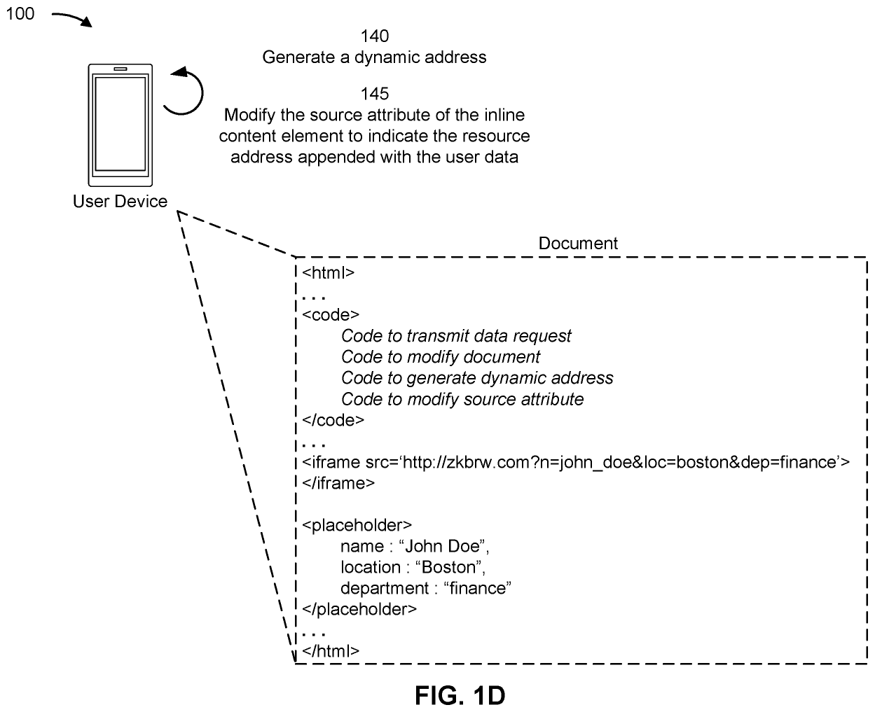

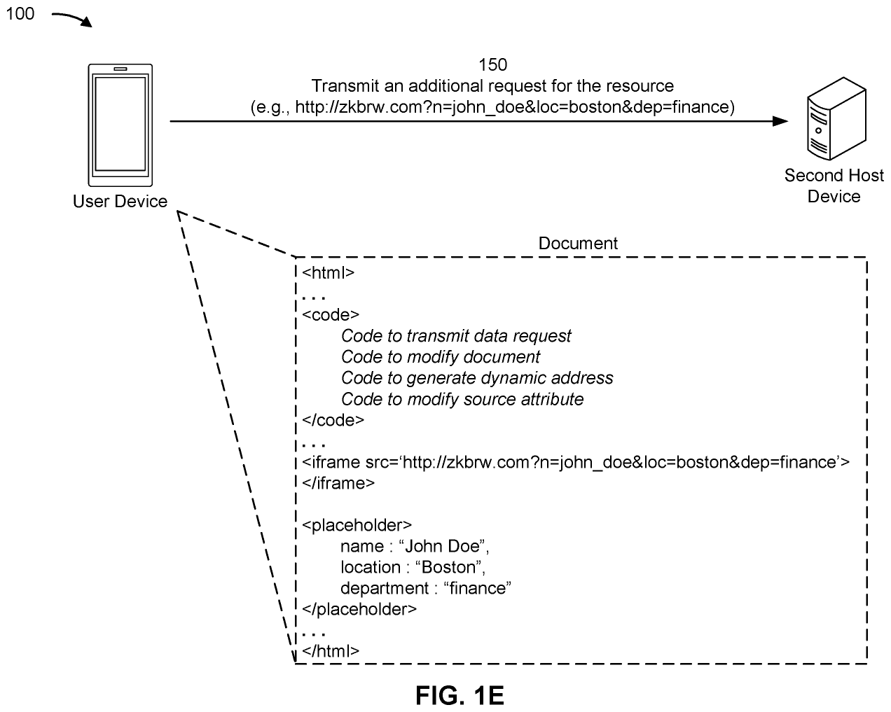

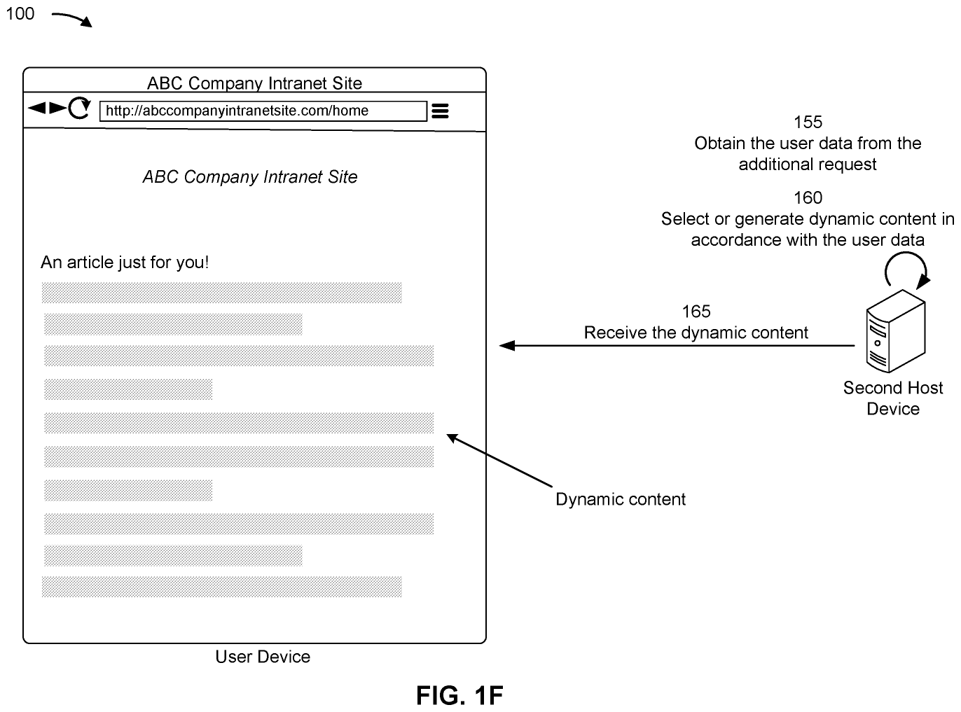

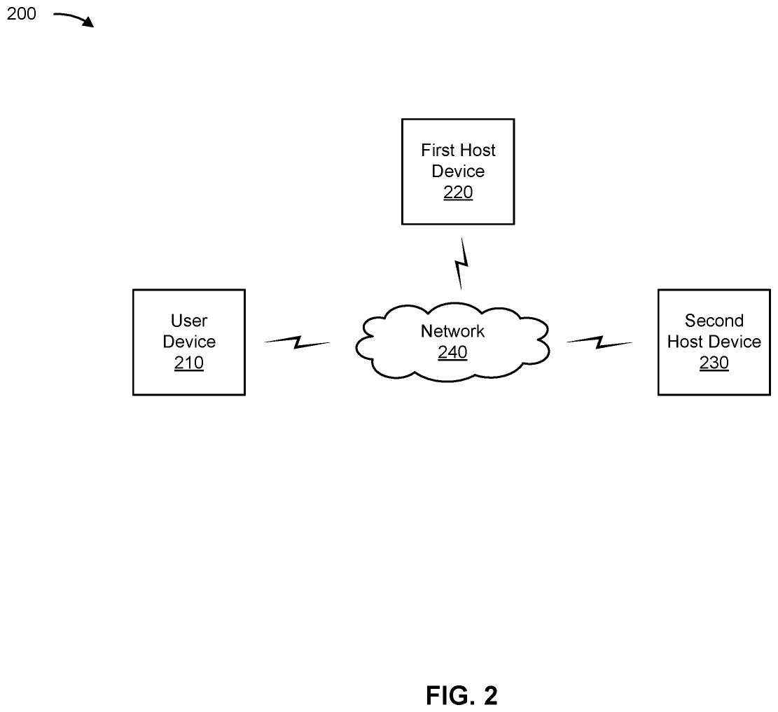

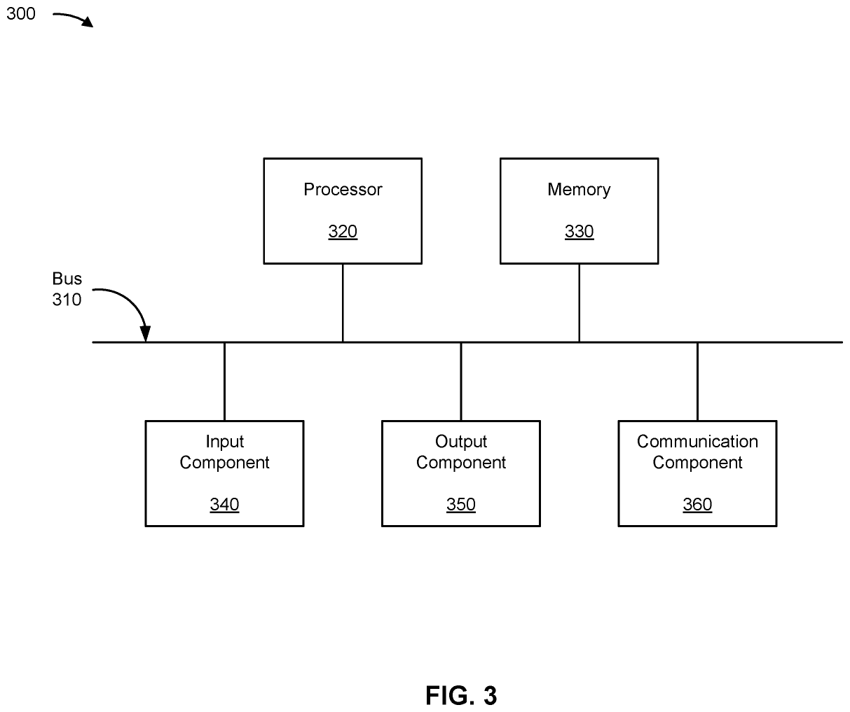

FIGS. 1A-1F are diagrams of an example 100 associated with passing data via an inline content element. For example, example 100 may be associated with passing data between devices. As shown in FIGS. 1A-1F, example 100 includes a user device, a first host device, and a second host device. These devices are described in more detail in connection with FIGS. 2 and 3.

The user device may be used by a user. The user device may implement a user interface for loading (e.g., displaying) documents. For example, the user device may implement a web browser (e.g., a web browser application) for loading web pages.

The first host device may host a document portal (e.g., a website) for serving documents (e.g., web pages) to user devices. For example, the first host device may implement a content management system that facilitates creation and publication of documents to the document portal. A content of the documents may originate from, or otherwise relate to, a third-party entity that does not exercise control over the first host device. For example, the first host device may host an intranet website on behalf of the third-party entity. In other examples, the document portal may include an email system or a web application. The user of the user device may be affiliated with the third-party entity (e.g., the user may be an employee of the third-party entity). In some implementations, the first host device may further implement a user management system for maintaining records relating to users of the document portal (e.g., users of the intranet website). For example, the records may indicate identifying information relating to the users, such as names of the users, residence locations of the users, office locations of the users, job titles of the users, departments to which the users belong, and/or employment statuses of the users (e.g., part time, full time, independent contractor, or the like), among other examples.

The second host device may host a resource configured to capture data that is passed to the resource. The third-party entity, or another entity unrelated to the first host device, may exercise control over the second host device. In either case, the third-party entity may exercise control over the resource (e.g., a content of the resource may originate from the third-party entity). The resource may include a serverless application, a web application (or “web app”), an application implemented by a server instance, an API endpoint, or the like. The resource may be accessible via a resource address (e.g., a uniform resource locator (URL)). In some implementations, the document portal of the first host device is accessible at a first domain and the resource of the second host device is accessible at a second domain (e.g., such that web browser cross-domain restrictions are applicable to interactions between the document portal and the resource).

Prior to the operations described in FIGS. 1A-1F, the user of the user device may be authenticated to access documents (e.g., web pages) in the document portal (e.g., the intranet website). For example, the user device may transmit authentication information (e.g., a username and a password) for the user to the first host device, and the first host device may authenticate the user based on the authentication information (e.g., if the authentication information matches the records of the first host device). Based on authenticating the user, the first host device may cause a cookie to be set on the user device, or may set a session variable for the user, indicating that the user is authenticated. For example, the cookie or the session variable may indicate an identifier of the user (e.g., a user ID).

As shown in FIG. 1A, and by reference number 105, the user device may receive a user input from the user indicating that a document (e.g., a web page) is to be displayed on the user device. For example, the user input may include selecting a link to the document in an email (e.g., which may be tailored to the user based on a persona type identified for the user), selecting the link in another document, inputting the link into the user interface (e.g., the web browser), or the like. In some implementations, the link may point to an address (e.g., a URL) that is customized for the user. For example, the address may include a parameter (e.g., in a query string) indicating a persona type associated with the user (e.g., that indicates a user type of the user and/or one or more characteristics of the user). Accordingly, the document may be configured with dynamic content for the user that is dictated by the persona indicated in the parameter.

As shown by reference number 110, the user device may transmit, to the first host device, a request for the document. For example, the request (e.g., a hypertext transfer protocol (HTTP) request) may be for a web page that is to be loaded in the web browser of the user device. The user device may transmit the request responsive to the user input. As described above, the user may be authenticated to access the document. As shown by reference number 115, the user device may receive, from the first host device, the document in response to the request. As shown in FIG. 1B, the user device may load the document (e.g., the web page) received from the first host device in the user interface (e.g., the web browser) of the user device. As described above, the document may be accessible at the first domain. In some implementations, as described above, the document (e.g., the web page) may be part of the intranet website.

The document may include non-user-specific content. “Non-user-specific content” may refer to content that is included in the document for any user that accesses the document (e.g., the content is not personalized for a particular user). The non-user-specific content may include an article, a blog post, informational text, a navigation menu, or the like. The document may also include code. The code may include client-side scripting. For example, the code may be executable in the web browser of the user device. As an example, the code may be JavaScript or another type of code capable of dynamic modification of the document. In some implementations, the code may be third-party code (e.g., code that is dictated by the third-party entity). For example, the content management system for the document portal may allow documents created for the document portal to include custom code.

The document may further include an inline content element embedded in the document. The inline content element may be a hypertext markup language (HTML) inline frame (iframe). The inline content element may have a source attribute. The source attribute may control content that is loaded into the inline content element. For example, when the source attribute is set to a particular URL, content that is accessible at that URL is loaded into the inline content element. In some implementations, in the document received from the first host device, the source attribute for the inline content element may be empty, may be set to a dummy or placeholder value (e.g., “about: blank”), or may be set to the resource address of the resource (e.g., with no query string appended to the resource address or with a parameter appended to the resource address indicating that the code has not been executed). Accordingly, when the user device first loads the document (e.g., the web page) in the user interface (e.g., the web browser), the inline content element may include blank content, a loading indicator, or the like.

As shown by reference number 120, the user device may execute the code. For example, the user device may execute the code in an environment of the web browser of the user device (e.g., the code is executed client side). Execution of the code may cause the user device to perform (e.g., asynchronously) a series of operations. As shown in FIG. 1C, and by reference number 125, due to execution of the code, the user device may transmit a data request relating to the user (e.g., indicating that user data relating to the user is being requested). For example, the data request may indicate a user identifier of the user (e.g., obtained by the user device from the cookie or the session variable set for the user). In some implementations, the data request may indicate particular user data that is being requested. In some implementations, the data request may be an asynchronous HTTP request (e.g., made via a call in the code). The user device may transmit the data request to a service endpoint (e.g., a URL). For example, the user device may transmit the data request via an API available through the service endpoint. The service endpoint (e.g., the API) may facilitate access to data maintained in the user management system. As an example, the service endpoint may be provided by the first host device.

As shown by reference number 130, the user device may receive, in response to the data request, user data (e.g., variables) relating to the user. The user device may receive the user data from the service endpoint (e.g., in an API response). The user data received by the user device may be held in a variable of the code. In some implementations, the user data may also include any user data extracted by the user device from the address of the document (e.g., which may indicate a persona type of the user, as described above). As shown by reference number 135, due to execution of the code, the user device may modify the document to include the user data in a placeholder element (e.g., a hidden element) of the document. For example, the user device may insert the user data into the placeholder element in a document object model (DOM) of the document. In this way, the user data may be statically integrated into the document to enable subsequent use of or reference to the user data.

As shown in FIG. 1D, and by reference number 140, due to execution of the code, the user device may generate (e.g., construct) a dynamic address for the resource that includes the resource address, indicating the resource, appended with the user data (e.g., in a query string). The resource address may be non-user-specific (e.g., the resource address may be the same regardless of which user is accessing the document). The user data may be user-specific (e.g., the user data may be particular to the user accessing the document), thereby adding a dynamic component to the dynamic address. For example, user data returned by the service endpoint may be different for different users and/or different each time the same user accesses a document.

As shown by reference number 145, due to execution of the code, the user device may modify the source attribute of the inline content element to indicate the resource address appended with the user data (i.e., the dynamic address). For example, the user device may insert the resource address appended with user data into the source attribute of inline content element in the DOM of the document. In some implementations, the user device may further append usage data to the resource address, which may indicate parameters relating to the user's usage of the document portal and/or the document (e.g., parameters such as a campaign indicator, a channel type, an exit type, time on page, an engagement percentage, scroll depth, a content author, content tags, a click-through rate, a session duration, interaction depth, or the like).

Modification of the source attribute may cause transmission of an additional request (e.g., an HTTP request) for the resource to the second host device, and loading of the resource in the inline content element. For example, as a result of modification of the source attribute (e.g., as a result of inserting the resource address appended with the user data into the source attribute), as shown in FIG. 1E, and by reference number 150, the user device may transmit the additional request for the resource to the second host device. The additional request for the resource may pass the user data appended to the resource address to the resource (e.g., modification of the source attribute may cause passing of the user data appended to the resource address to the resource). For example, the additional request for the resource may indicate the resource address appended with the user data, thereby enabling extraction of the user data. In some implementations, usage data appended to the resource address may be aggregated locally at the user device before transmission to the second host device, thereby reducing server requests and conserving network resources.

As shown in FIG. 1F, and by reference number 155, the second host device, using the resource, may obtain the user data from the additional request. In addition, the second host device, using the resource, may obtain an address (e.g., a URL) associated with the document (e.g., by capturing a referring address to the resource). In some implementations, the user data may indicate a user identifier, and the second host device may retrieve additional data relating to the user from one or more sources using the user identifier. In some implementations, the second host device, using the resource, may store, or cause storage of, the user data (e.g., to a data pool). For example, the second host device may store, or cause storage of, the user data in a log (e.g., a log of view counts, of user interactions with content, or the like) indicating that the document was accessed by the user. For example, the log may be implemented in an application (e.g., separate from the resource), such as a spreadsheet application, that is implemented by the second host device or a different device. In this way, the log can be filtered, sorted, queried, or the like, to identify (e.g., using a machine learning model) user engagement and content effectiveness associated with various documents. In some examples, the user data and/or the usage data may indicate technical issues with the document portal and/or the document. In some implementations, the second host device, using the resource, may retrieve additional data from other sources (e.g., survey data, sentiment data, feedback data, or the like) for integration with the user data (e.g., in the application). In some implementations, the second host device may utilize batch processing when retrieving the additional data to minimize API calls, thereby conserving network resources.

As shown by reference number 160, the second host device may select or generate dynamic content (e.g., personalized content) in accordance with the user data. For example, characteristics of the user indicated by the user data may dictate the dynamic content. As an example, if the user data indicates that the user works in a finance department of the third-party entity, then the second host device may select or generate (e.g., using a machine learning model) dynamic content relating to finance. As shown by reference number 165, responsive to the additional request, the second host device may transmit, and the user device may receive, the dynamic content. Reception of the dynamic content may cause the user device to load the dynamic content in the inline content element. In this way, on-page personalization is achieved on the same page from which the user data and/or usage data is captured (e.g., rather than capturing the data on a first page and personalizing a second page based on the captured data, which is inefficient). Thus, dynamic content can be provided relatively sooner in the user's session, and a number of server requests that need to be made before relevant content is provided to the user can be reduced, thereby conserving computing resources and network resources.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a user device 210, a first host device 220, a second host device 230, and a network 240. Devices of environment 200 may interconnect via wired connections, wireless connections, or a combination of wired and wireless connections.

The user device 210 may include one or more devices capable of receiving, generating, storing, processing, and/or providing information associated with passing data via an inline content element, as described elsewhere herein. The user device 210 may include a communication device and/or a computing device. For example, the user device 210 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The first host device 220 may include one or more devices capable of receiving, generating, storing, processing, providing, and/or routing information associated with passing data via an inline content element, as described elsewhere herein. The first host device 220 may include a communication device and/or a computing device. For example, the first host device 220 may include a server, such as an application server, a client server, a web server, a database server, a host server, a proxy server, a virtual server (e.g., executing on computing hardware), or a server in a cloud computing system. In some implementations, the first host device 220 may include computing hardware used in a cloud computing environment.

The second host device 230 may include one or more devices capable of receiving, generating, storing, processing, providing, and/or routing information associated with passing data via an inline content element, as described elsewhere herein. The second host device 230 may include a communication device and/or a computing device. For example, the second host device 230 may include a server, such as an application server, a client server, a web server, a database server, a host server, a proxy server, a virtual server (e.g., executing on computing hardware), or a server in a cloud computing system. In some implementations, the second host device 230 may include computing hardware used in a cloud computing environment.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with passing data via an inline content element. The device 300 may correspond to the user device 210, the first host device 220, and/or the second host device 230. In some implementations, the user device 210, the first host device 220, and/or the second host device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

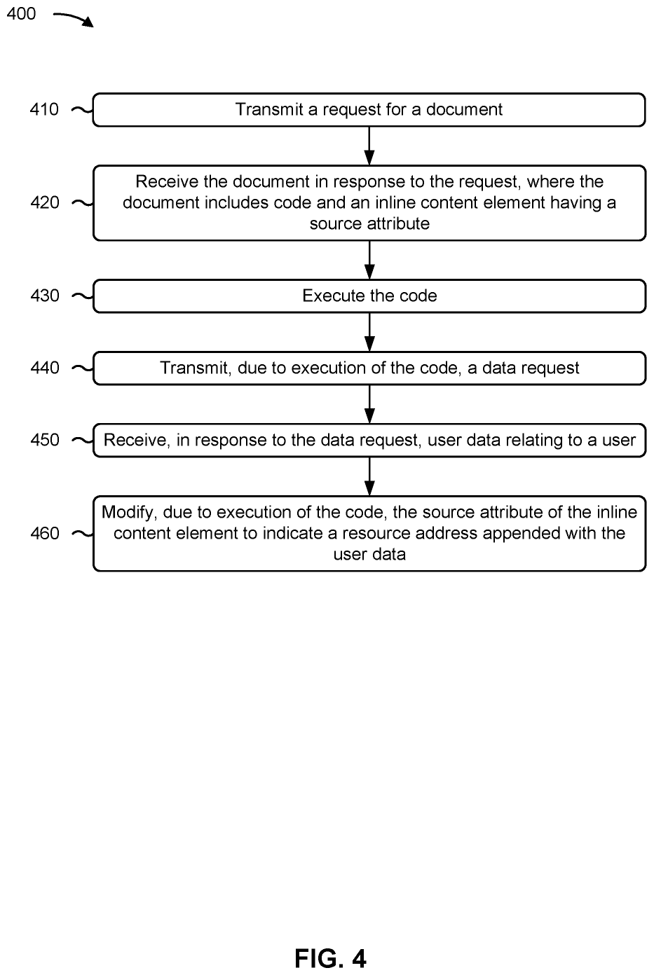

FIG. 4 is a flowchart of an example process 400 associated with passing data via an inline content element. In some implementations, one or more process blocks of FIG. 4 may be performed by the user device 210. In some implementations, one or more process blocks of FIG. 4 may be performed by another device or a group of devices separate from or including the user device 210, such as the first host device 220 and/or the second host device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include transmitting a request for a document (block 410). For example, the user device 210 (e.g., using processor 320, memory 330, and/or communication component 360) may transmit a request for a document, as described above in connection with reference number 110 of FIG. 1A. As an example, the request may be an HTTP request for a web page that is to be loaded in a web browser.

As further shown in FIG. 4, process 400 may include receiving the document in response to the request, where the document includes code and an inline content element having a source attribute (block 420). For example, the user device 210 (e.g., using processor 320, memory 330, and/or communication component 360) may receive the document in response to the request, as described above in connection with reference number 115 of FIG. 1A. As an example, the user device 210 may load the web page received from the first host device in the web browser of the user device 210.

As further shown in FIG. 4, process 400 may include executing the code (block 430). For example, the user device 210 (e.g., using processor 320 and/or memory 330) may execute the code, as described above in connection with reference number 120 of FIG. 1B. As an example, the user device 210 may execute the code in an environment of the web browser of the user device 210.

As further shown in FIG. 4, process 400 may include transmitting, due to execution of the code, a data request (block 440). For example, the user device 210 (e.g., using processor 320, memory 330, and/or communication component 360) may transmit, due to execution of the code, a data request, as described above in connection with reference number 125 of FIG. 1C. As an example, the data request may be an asynchronous HTTP request (e.g., to an API endpoint) for user data.

As further shown in FIG. 4, process 400 may include receiving, in response to the data request, user data relating to a user (block 450). For example, the user device 210 (e.g., using processor 320, memory 330, and/or communication component 360) may receive, in response to the data request, user data relating to a user, as described above in connection with reference number 130 of FIG. 1C. As an example, the user data may indicate a name of the user, a residence location of the user, an office location of the user, a job title of the user, a department to which the user belongs, an employment status of the user, and/or a persona associated with the user, among other examples.

As further shown in FIG. 4, process 400 may include modifying, due to execution of the code, the source attribute of the inline content element to indicate a resource address appended with the user data (block 460). For example, the user device 210 (e.g., using processor 320 and/or memory 330) may modify, due to execution of the code, the source attribute of the inline content element to indicate a resource address appended with the user data, as described above in connection with reference number 145 of FIG. 1D. As an example, modification of the source attribute may cause passing of the user data appended to the resource address to the resource (e.g., via an additional request made to the resource address appended with the user data).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for passing data between devices, the system comprising:
one or more memories; and
one or more processors, communicatively coupled to the one or more memories, configured to:
transmit, to a first host device, a request for a web page to be loaded in a web browser,
wherein the request is responsive to a user input from a user that is authenticated to access the web page;
receive, from the first host device, the web page in response to the request,
wherein the web page includes code executable by the web browser and an inline content element having a source attribute;
execute the code in an environment of the web browser;
transmit, due to execution of the code and to a service endpoint, a data request that includes a user identifier of the user;
receive, from the service endpoint in response to the data request, user data relating to the user;
modify, due to execution of the code, the source attribute of the inline content element to indicate a resource address appended with the user data,
wherein the resource address indicates a resource; and
transmit, as a result of modification of the source attribute and to a second host device, an additional request for the resource that passes the user data appended to the resource address to the resource.

2. The system of claim 1, wherein the one or more processors, to transmit the data request, are configured to:
transmit the data request via an application programming interface available through the service endpoint.

3. The system of claim 1, wherein the inline content element is a hypertext markup language (HTML) inline frame.

4. The system of claim 1, wherein the one or more processors are further configured to:
receive, from the second host device and responsive to the additional request, dynamic content for the inline content element,
wherein the dynamic content is dictated by the user data.

5. The system of claim 1, wherein the one or more processors, to modify the source attribute of the inline content element, are configured to:
insert the resource address appended with the user data into the source attribute of the inline content element in a document object model for the web page.

6. The system of claim 1, wherein the web page is accessible at a first domain and the resource is accessible at a second domain.

7. The system of claim 1, wherein the web page is part of an intranet website.

8. The system of claim 1, wherein the resource address is non-user-specific and the user data is user-specific.

9. A method of passing data between devices, comprising:
transmitting, by a user device to a first host device, a request for a document,
wherein the user device is used by a user;
receiving, by the user device from the first host device, the document in response to the request,
wherein the document includes code and an inline content element having a source attribute;
transmitting, by the user device and due to execution of the code, a data request relating to the user;
receiving, by the user device and in response to the data request, user data relating to the user;
inserting, by the user device and due to execution of the code, a resource address appended with the user data into the source attribute of the inline content element in a document object model of the document,
wherein the resource address indicates a resource; and
transmitting, by the user device, to a second host device, and as a result of inserting the resource address appended with the user data into the source attribute, an additional request for the resource that passes the user data appended to the resource address to the resource.

10. The method of claim 9, further comprising:
generating, due to the execution of the code, a dynamic address for the resource that includes the resource address appended with the user data.

11. The method of claim 9, further comprising:
receiving, from the second host device and responsive to the additional request, dynamic content for the inline content element,
wherein the dynamic content is dictated by the user data.

12. The method of claim 9, wherein the document further includes non-user-specific content.

13. The method of claim 9, wherein the resource address is non-user-specific and the user data is user-specific.

14. The method of claim 9, wherein the document is a web page and the resource is a serverless application.

15. A non-transitory computer-readable medium storing a set of instructions for passing data between devices, the set of instructions comprising:
one or more instructions that, when executed by one or more processors of a device, cause the device to:
transmit a request for a document;
receive the document in response to the request,
wherein the document includes code and an inline content element having a source attribute;
execute the code;
transmit, due to execution of the code, a data request;
receive, in response to the data request, user data relating to a user; and
modify, due to execution of the code, the source attribute of the inline content element to indicate a resource address appended with the user data,
wherein the resource address indicates a resource, and
wherein modification of the source attribute is to cause passing of the user data appended to the resource address to the resource.

16. The non-transitory computer-readable medium of claim 15, wherein the resource is a serverless application.

17. The non-transitory computer-readable medium of claim 15, wherein the one or more instructions, that cause the device to modify the source attribute of the inline content element, cause the device to:
insert the resource address appended with the user data into the source attribute of the inline content element in a document object model for the document.

18. The non-transitory computer-readable medium of claim 15, wherein the one or more instructions, when executed by the one or more processors, further cause the device to:
modify, due to the execution of the code, the document to include the user data in a placeholder element of the document.

19. The non-transitory computer-readable medium of claim 15, wherein the one or more instructions, when executed by the one or more processors, further cause the device to:
transmit, as a result of modification of the source attribute, an additional request for the resource that passes the user data appended to the resource address to the resource.

20. The non-transitory computer-readable medium of claim 19, wherein the one or more instructions, when executed by the one or more processors, further cause the device to:
receive, responsive to the additional request, dynamic content for the inline content element,
wherein the dynamic content is dictated by the user data.
